(19) United States
(12) Patent Application Publication
(10) Pub. No.: US 2019/0106279 A1
(43) Pub. Date: Apr. 11, 2019

(54) UTILITY TRAILER WITH REMOVABLE DUMPSTER

(71) Applicant: Martin Perry HEARD, Lubbock, TX (US)

(72) Inventor: Martin Perry HEARD, Lubbock, TX (US)

(21) Appl. No.: 16/153,983

(22) Filed: Oct. 8, 2018

Related U.S. Application Data
(60) Provisional application No. 62/568,973, filed on Oct. 6, 2017.

(51) Int. Cl. B65F 3/26; B65F 3/08; B65F 1/14; B60P 1/64

(52) U.S. Cl. CPC B65F 3/26; B65F 3/08; B60P 1/08; B60P 1/6445; B65F 1/1473

(57) ABSTRACT

The present invention relates to an utility trailer with removable self-dumping dumpster and trailer assembly particularly suitable for hauling refuse and yard waste.

This application claims the benefit of U.S. Provisional Application No. 62/568,973, filed Oct. 6, 2017. The disclosure of the priority application is hereby incorporated in its entirety by reference.

The present invention relates to an utility trailer with removable dumpster useable with a trailer assembly particularly suitable for hauling refuse and yard waste.

### BACKGROUND

The removal of refuse and yard waste has frequently been accomplished through a system whereby small containers hold the refuse or waste at a residential location until the contents of those containers can be transferred to a vehicle having a larger container, i.e., dump truck, that can then transfer the refuse or waste to a dump or waste transfer facility.

One problem that may arise, particularly in rural settings, is that there are insufficient residents to justify a waste removal service. There remains a need for a convenient waste receptacle that can be conveniently transport waste or refuse to a dump or waste transfer facility.

### SUMMARY OF THE INVENTION

In an embodiment, the present invention relates to a trailer dumpster comprising: a dumpster body having a refuse container and an axle cylinder; and a trailer comprising a trailer axle, and two or more tires attached to the trailer axle, a receiver adapted to receive the axle cylinder of the dumpster body, and a retainer for holding the axle cylinder within the receiver, wherein the dumpster body is rotatable with respect to the trailer and the dumpster can be separated from the trailer by removing or repositioning the retainer. The axle cylinder can be at least partially hollow, and may allow the dumpster body to be rotatable relative to the trailer. In one aspect, the dumpster body is held on the trailer by a saddle receiver and a pin (i.e., saddle pin) that holds the axle within the saddle receiver. The saddle pin may be held in place within the saddle using a cotter pin or similar retaining device. In one aspect, the rear wall of the dumpster body may be retained in the dumpster body by grooves in the rear portion of the sidewalls of the dumpster body, and may be removed by lifting the rear wall until the grooves are cleared.

In another aspect, the present invention relates to methods of hauling or disposing of refuse. The method may comprise adding refuse to a refuse container, the refuse container and an axle cylinder forming a dumpster body; removing or repositioning a retainer for holding the axle cylinder of the dumpster body within a receiver on a trailer body, the trailer body comprising a trailer axle, and two or more tires attached to the trailer axle; removing the dumpster body and axle cylinder from the receiver on the trailer body; tilting the dumpster body by elevating a front portion of the dumpster body; and removing the refuse from the refuse container. In other aspects of the method the rear wall of the dumpster body may be removed by sliding the wall upward. In addition, a hoist stand may be used to elevate the front portion of the dumpster body.

### BRIEF DESCRIPTION OF THE DRAWING

FIG. 1 is a perspective view showing the point of attachment between the removable dumpster and the trailer in accordance with an aspect of the invention.

FIG. 2 is a side view of the dumpster after being attached from the trailer in accordance with an aspect of the invention.

FIG. 3 is a side view of the dumpster sitting on the ground next to the trailer in accordance with an aspect of the invention.

FIG. 4 shows the dumpster being lifted by the portable chain hoist stand in accordance with an aspect of the invention.

### DETAILED DESCRIPTION OF THE PREFERRED EMBODIMENTS

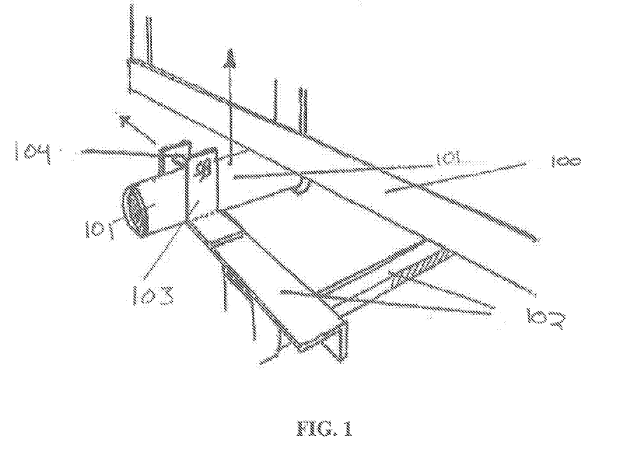

The present invention relates to a dumpster 100 that can be easily removed from a trailer 102 making it more useful for the hauling of refuse in a rural environment. The dumpster includes an axle member 101 that interfaces with a saddle bracket 103 and saddle pin 104 for holding the dumpster on the trailer 102 as shown in FIG. 1. The axle member 101 may comprise a cylinder that extends across the entire width of the dumpster 100 so it can interface with saddle brackets 103 found on both sides of the trailer body for easy attachment to and release from the trailer body 102. The dumpster body may include an open top such that refuse is contained within the four walls of the dumpster body. In one aspect, the rear facing wall of the dumpster may be removed, for example, by sliding it upward and out when the rear wall is held in place by grooves in the frame of the dumpster body.

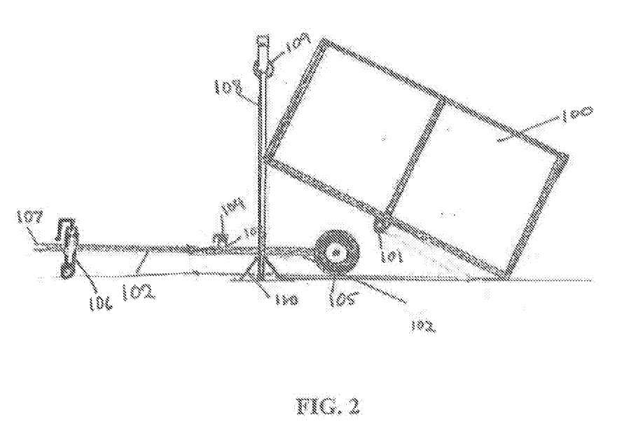

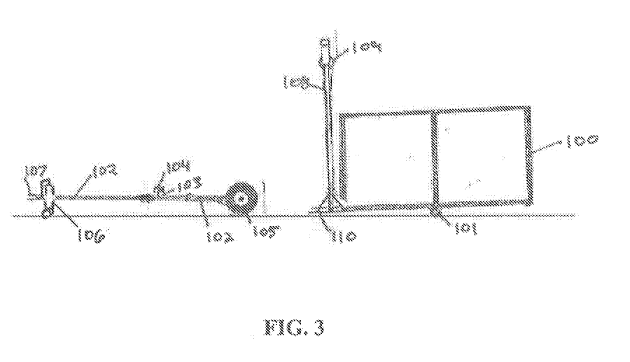

As shown in FIG. 2, the trailer body 102 may include main wheels 105 and a front stand 106 that secures the front of the dumpster body 100 to the trailer body 102. The front stand 106 may include a jack that can be used to set the trailer and dumpster at a level attitude. This may be desirable for attaching the trailer to a vehicle by way of the hitch 107. The front stand 106 may include a wheel or a stand for contacting the ground. The front stand 106 may also include a member that can be attached to the front of the dumpster body 100 to hold it in place during transportation. In one aspect, the member may be a latch that can be manually lifted to free the front of the dumpster body 100 before detachment from the trailer via removal of the saddle pin 104. Alternatively, the front of the trailer may be connected to the front stand 106 using a bolt or any other means of attachment. As shown in FIG. 3, the dumpster body may be completely removed from the trailer 102.

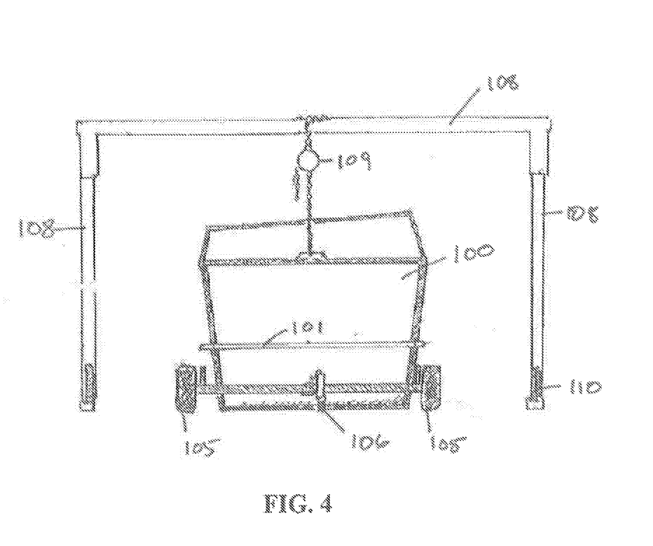

The dumpster body 100 may also be used with a portable chain hoist stand 108 as shown in FIG. 4. The stand includes a chain 109 attached to a horizontal top beam of the stand for hoisting the front of the dumpster body 100. The stand includes a stabilizing ground support 110 for ensuring the stand 108 remains upright while supporting the weight of the loaded dumpster 100. Because the dumpster body 100 can be removed from the trailer 102, it is possible to transport one dumpster body 100 that is full while another dumpster body is being filled and/or awaiting removal. The present invention allows for a system for refuse removal that can be easily operated by a single person that is particularly suited to rural environments.

While various embodiments of the invention have been described in terms of various specific embodiments, those skilled in the art will appreciate and recognize that the invention can be practiced with modifications within the spirit and scope of the claims.

1. A trailer dumpster comprising:
a dumpster body having a refuse container and an axle cylinder; and
a trailer comprising a trailer axle, and two or more tires attached to the trailer axle, a receiver adapted to receive the axle cylinder of the dumpster body, and a retainer for holding the axle cylinder within the receiver, wherein the dumpster body is rotatable with respect to the trailer and the dumpster can be separated from the trailer by removing or repositioning the retainer.

2. The trailer dumpster of claim 1, wherein the axle cylinder is at least partially hollow.

3. The trailer dumpster of claim 1, wherein the axle cylinder comprises at least two cylindrical portions that allow the dumpster body to be rotatable when the axle cylinder is inserted into the receiver.

4. The trailer dumpster of claim 1, wherein the removable retainer is a saddle pin.

5. The trailer dumpster of claim 4, wherein the saddle pin further comprises a cotter pin.

6. The trailer dumpster of claim 1, wherein the receiver is a saddle receiver and the removable retainer is a saddle pin that holds the axle cylinder in place when the dumpster body is attached to the trailer.

7. The trailer dumpster of claim 1, wherein the dumpster body includes a rear wall that is removable by sliding it upward until it is free of one or more grooves provided in one or more walls of the dumpster body.

8. A method of disposing of refuse comprising:
adding refuse to a refuse container, the refuse container and an axle cylinder forming a dumpster body;
removing or repositioning a retainer for holding the axle cylinder of the dumpster body within a receiver on a trailer body, the trailer body comprising a trailer axle, and two or more tires attached to the trailer axle;
removing the dumpster body and axle cylinder from the receiver on the trailer body;
tilting the dumpster body by elevating a front portion of the dumpster body; and
removing the refuse from the refuse container.

9. The method of claim 8, further comprising removing a rear wall of the dumpster body by sliding the wall upward.

10. The method of claim 8, further comprising using a hoist stand to elevate the front portion of the dumpster body.
